(19) United States
(12) Patent Application Publication
(10) Pub. No.: US 2016/0255348 A1
(43) Pub. Date: Sep. 1, 2016

(54) ADAPTIVE JOINT BITRATE ALLOCATION

(71) Applicant: ARRIS Enterprises, Inc., Suwanee, GA (US)

(72) Inventors: Ramesh V. Panchagnula, Norcross, GA (US); Alexander D. Raji, Alpharetta, GA (US)

(21) Appl. No.: 15/054,648

(22) Filed: Feb. 26, 2016

Related U.S. Application Data
(60) Provisional application No. 62/121,563, filed on Feb. 27, 2015.

(51) Int. Cl. H04N 19/134; H04N 19/196; H04N 19/184; H04N 19/115; H04N 19/146

(52) U.S. Cl. CPC H04N 19/134; H04N 19/115; H04N 19/146; H04N 19/184; H04N 19/196

(57) ABSTRACT

A method of encoding digital content is provided that allows for adaptive joint bitrate allocation that allocates bits for audio and video. The method includes: determining an overall transport stream bitrate, determining a target audio bitrate for each audio stream based on their complexity, determining a portion of the overall transport stream bitrate available for video streams by subtracting the sum of the target audio bitrates from the overall transport stream bitrate, allocating a target video bitrate for each video streams out of the portion of the overall transport stream bitrate available for video streams, encoding audio streams at the target audio bitrates, encoding video streams at the target video bitrates, and combining the audio streams and video streams with a multiplexor into a transport stream.

### CLAIM OF PRIORITY

This application claims priority under 35 U.S.C. §119(e) from earlier filed U.S. Provisional Application Ser. No. 62/121,563, filed Feb. 27, 2015, which is hereby incorporated by reference.

### TECHNICAL FIELD

The present disclosure relates to the field of audio and video compression, particularly methods of jointly managing bitrates for audio and video components of a transport stream.

### BACKGROUND

Digital transmission of audiovisual content to playback devices has become increasingly popular. However, the bandwidth available to most devices is limited. As such, content providers have attempted to lower encoding bitrates as much as possible, while still maintaining or even improving the perceived quality level of digital content. For instance, video and audio coding technologies such as High Efficiency Video Coding (HEVC), Advanced Video Coding (AVC/H.264), AAC, and HE-AAC have been developed that attempt to encode content at relatively low bitrates while keeping encoding quality high.

Digital transmission of content generally involves encoding the content's audio and video components into separate audio and video streams. Corresponding audio and video streams can then be multiplexed together into a single transport stream that can be decoded for playback. Most efforts to reduce the transport stream's overall bitrate have been focused on reducing the video component's bitrate, as the video component takes up the majority of the overall bitrate.

For instance, encoding schemes have been developed that encode video streams at a variable bitrate depending on the content of the video, to save bits on less complex portions of the video. However, even when video streams are encoded at variable bitrates, audio encoding is still normally done at a constant, preset bitrate.

However, dedicating a constant bitrate to audio streams can be wasteful. In many situations, human listeners would not perceive a difference between audio signals encoded at a high bitrate or a low bitrate. For example, when an audio soundtrack is silent for a moment on one or more channels, a human listener would perceive the same silence at a high bitrate or a low bitrate. As such, the bitrate of an audio stream can be varied depending on its content without significantly impacting how a human listener would perceive the audio stream.

### SUMMARY

What is needed is a method for selecting variable audio bitrates for encoding content based on its audio complexity without decreasing the audio stream's perceived quality to a human listener, and for applying any savings on the audio bitrates toward increasing bitrates of a video stream to improve its visual quality.

In one embodiment, the present disclosure provides for a method of encoding digital content, the method comprising determining, with a video encoding system, an overall transport stream bitrate for a transport stream, determining, with the video encoding system, a target audio bitrate for each of one or more audio streams based on the complexity of one or more associated source audio components, determining, with the video encoding system, a portion of the overall transport stream bitrate that is available for video streams, by subtracting the sum of the target audio bitrates from the overall transport stream bitrate, allocating, with the video encoding system, a target video bitrate for each of one or more video streams out of the portion of the overall transport stream bitrate that is available for video streams, encoding the one or more audio streams at the target audio bitrates with one or more audio encoders, encoding the one or more video streams at the target video bitrates with one or more video encoders, and combining the one or more audio streams and the one or more video streams with a multiplexor into a transport stream.

In another embodiment, the present disclosure provides for a method of encoding digital content, the method comprising receiving a segment of a source audio component at an audio encoder, the audio source component having one or more channels, setting a target audio bitrate at the audio encoder, decreasing the target audio bitrate at the audio source component and increasing target video bitrates at one or more linked video encoders when one or more video encoders requests an increase in their target video bitrates based on the complexity level of source video components, and encoding the segment at the target audio bitrate into an audio stream.

In another embodiment, the present disclosure provides for a method of encoding digital content, the method comprising receiving a segment of a source video component at a video encoder, estimating a target video bitrate with the video encoder for a video stream, based on the complexity level of the source video component, decreasing a target audio bitrate for an audio stream to as low as a minimum preset value for the audio stream's channel configuration based on the audio stream's complexity level and increasing the target video bitrate by a corresponding amount, upon a determination that the target video bitrate is higher than a portion of an overall transport stream bitrate available for the video stream, encoding the segment at the target video bitrate, and encoding the audio stream at the target audio bitrate.

### BRIEF DESCRIPTION OF THE DRAWINGS

Further details of the present invention are explained with the help of the attached drawings in which:

FIG. 1 depicts a video encoding system comprising one or more video encoders, one or more audio encoders, a multiplexor, and/or a rate controller.

FIG. 2 depicts a video encoding system producing a plurality of substreams for adaptive bitrate streaming.

FIG. 3 depicts a video encoding system producing chunks of a substream on demand for a client device.

FIG. 4 depicts a pie chart illustrating the interaction between audio bitrates and video bitrates within a transport stream.

FIG. 5 depicts a process for determining target audio bitrates, and using those target audio bitrates to allocate target video bitrates.

FIG. 6 depicts a flow chart of one exemplary method for adaptively determining a target audio bitrate and a target video bitrate for a piece of source content.

FIG. 7 depicts a flow chart of a method for determining target audio bitrates and target video bitrates for an SPTS (Single Program Transport Stream).

FIG. 8 depicts a flow chart of a method for determining target audio bitrates and target video bitrates for substreams for “just-in-time” adaptive bitrate transcoding.

### DETAILED DESCRIPTION

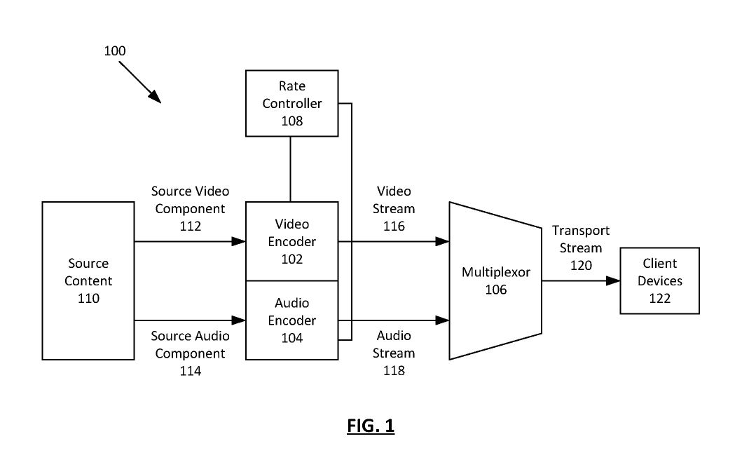

FIG. 1 depicts a video encoding system 100 comprising one or more video encoders 102, one or more audio encoders 104, and a multiplexor 106. In some embodiments, the video encoding system 100 can further comprise a rate controller 108 in data communication with the video encoder 102 and the audio encoder 104. The video encoders 102, audio encoders 104, multiplexor 106, and/or rate controller 108 can each comprise processors, memory, circuits, and/or other hardware and software elements. In some embodiments, some or all of the video encoders 102, audio encoders 104, multiplexor 106, and rate controller 108 can be combined into the same hardware or software component. In other embodiments, some or all of the video encoders 102, audio encoders 104, multiplexor 106, and rate controller 108 can be separate hardware or software components that are linked in data communication with one another.

Sources, such as broadcasters or content providers, can provide the video encoding system 100 with pieces of source content 110. In some embodiments, the video encoding system 100 can receive source content 110 over a network or other data connection from sources, while in other embodiments source content 110 can be files loaded to components of the video encoding system 100 from hard disks, flash drives, or other memory storage devices. Source content 110 can be audiovisual programs, such as videos, movies, television programs, live broadcasts, or any other type of program. Video and audio information from each piece of source content 110 can be encoded or transcoded separately by the video encoding system 100 as a source video component 112 and a source audio component 114.

A video encoder 102 can be configured to encode or transcode a source video component 112 into a video stream 116. By way of a non-limiting example, a video encoder 102 can encode or transcode a source video component 112 into a video stream 116 using an encoding and/or compression scheme or codec, such as High Efficiency Video Coding (HEVC), Advanced Video Coding (MPEG-4 AVC/H.264), or MPEG-2.

Similarly, an audio encoder 104 can be configured to encode or transcode a source audio component 114 into an audio stream 118. By way of a non-limiting example, an audio encoder 104 can encode or transcode a source audio component 114 into an audio stream 118 using an encoding and/or compression scheme or codec, such as Advanced Audio Coding (AAC), High-Efficiency Advanced Audio Coding (HE-AAC), or Audio Coding 3 (AC-3). In some embodiments, audio encoding and/or transcoding can comprise compressing audio from a stream of sampled audio signals, such as pulse-code modulation (PCM) signals into a series of compressed audio packets. The compressed audio packets can be decoded by a decoding device into a stream of PCM values for playback that approximate the original PCM signals.

Audio streams 118 can be encoded with one or more channels. By way of non-limiting examples, a mono audio stream 118 can have a single channel, a stereo audio stream 118 can have a left channel and a right channel, and a 5.1 surround sound audio stream 118 can have channels for each speaker and subwoofer in a surround sound setup. When an audio stream 118 has more than channel, each channel can carry different audio signals intended for different speakers. The channels can thus have different audio complexities relative to one another at varying points in time. By way of a non-limiting example, at a particular point in time a center channel might be carrying dialog, left and right channels might be carrying sound effects and music, and rear channels might be silent.

The multiplexor 106 can receive multiple elementary streams, such as a video stream 116 and an audio stream 118, and combine them into a transport stream 120. By way of a non-limiting example, the transport stream 120 can be an MPEG transport stream. The transport stream 120 can be sent to client devices 122 or other devices over a network or data connection, such that they can decode a video stream 116 and an audio stream 118 from the transport stream 120 to substantially reconstruct a piece of source content 110 for playback. By way of non-limiting examples, a transport stream 120 can be sent to a client device 122 such as a television, cable box, set top box, or any other device configured to receive and decode a transport stream 120. In some embodiments, timestamps can be periodically inserted within a transport stream 120, such that associated video streams 116 and audio streams 118 can be synchronized for playback relative to the timestamps.

Although FIG. 1 depicts an embodiment with a single video encoder 102 and audio encoder 104, in other embodiments the video encoding system 100 can comprise multiple video encoders 102 and/or audio encoders 104, such that the video encoding system 100 can encode and multiplex multiple pieces of source content 110, or encode and multiplex multiple audio streams 118 associated with the same video stream 116.

In some embodiments, a transport stream 120 can be a Multiple Program Transport Stream (MPTS) where elementary streams for multiple programs or pieces of source content 110 are multiplexed together. By way of a non-limiting example, an MPTS can comprise video streams 116 and audio streams 118 for many different programs. A decoding client device 122 can receive the MPTS, find video streams 116 and audio streams 118 within the MPTS that are associated with a particular program that a viewer wants to watch, and decode and play back the selected streams while ignoring others.

In other embodiments, a transport stream 120 can be a Single Program Transport Stream (SPTS) that includes elementary streams for a single program or piece of source content 110. By way of a non-limiting example, an SPTS can comprise a single video stream 116 and one or more associated audio streams 118, such as alternate language tracks and/or commentary tracks for the same video.

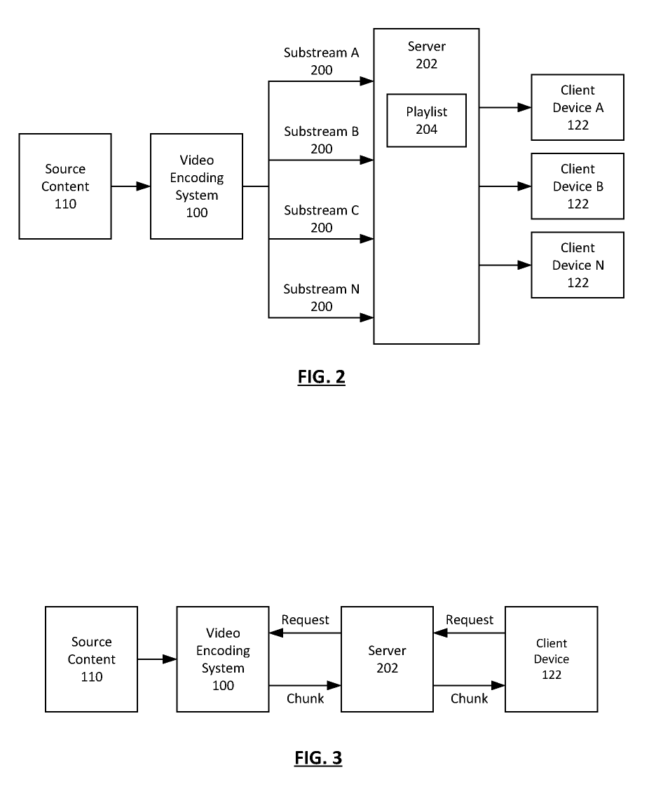

In still other embodiments, the video encoding system 100 can generate one or more substreams 200 for each piece of source content 110 as shown in FIG. 2. The substreams 200 can be separately available to client devices 122 for adaptive bitrate streaming solutions, such as MPEG-DASH, HTTP Live Streaming (HLS), and HTTP Smooth Streaming. The substreams 200 can each be transport streams 120, such as Single Program Transport Streams, produced at varying quality levels, bitrates, framerates, and/or resolutions. The substreams 200 can be individually delivered to client devices 122 through a server 202.

In some embodiments each substream 200, and/or individual chunks of each substream 200, can be listed on a playlist 204 or other manifest that is available to downstream client devices 122, as shown in FIG. 2. Each client device 122 can choose which substream 200 to request, based on its currently available bandwidth and network conditions, and/or its own display resolution and audio capabilities. As network conditions change during playback, client devices 122 can switch between different substreams 200. By way of a non-limiting example, a client device 122 can initially request a high quality substream 200, but then move to a lower quality substream 200 that was encoded at a lower bitrate when the bandwidth available to the client device 122 decreases. In these embodiments, the video encoding system 100 can encode and/or transcode the same piece of source content 110 at a plurality of different quality levels, bitrates, and/or resolutions, to produce a plurality of different versions of a transport stream 120 from the same source content 110.

In some embodiments, one or more substreams 200 can be produced on demand for particular types of client devices 122, with attributes such as resolution, framerate, and bitrate being customized for particular client devices 122. Producing substreams 200 on demand can be referred to as “just-in-time” adaptive bitrate transcoding. FIG. 3 depicts an exemplary embodiment of “just-in-time” adaptive bitrate transcoding with the video encoding system 100. In these embodiments, each client device 122 can send requests to a server 202 that indicates identifying information about the client device 122 such as its type, operating system, IP address, display resolution, audio configuration, and/or any other data. By way of a non-limiting example, a request can be an HTTP request that indicates the client device's operating system in its header.

Each request sent by a client device 122 can additionally indicate the identity of a requested chunk and a requested bitrate. By way of a non-limiting example, a client device 122 can review a playlist 204 on a server 202 that lists available chunks of the source content 110, and then sent a request that asks for a particular chunk at a particular bitrate, such as a bitrate that can be delivered over the client device's currently available bandwidth. The video encoding system 100 can receive the client device's request through the server 202. If a substream 200 is already being encoded for another client device 122 of the same type at the same specifications, the video encoding system 100 can transfer a copy of requested chunk to the new client device 122 from that substream 200. However, if the new client device 122 is requesting a chunk at a different resolution, framerate, or bitrate than any substream 200 already being generated, the video encoding system 100 can encode or transcode that chunk of the source content 110 at the requested specifications specifically for the new client device 122.

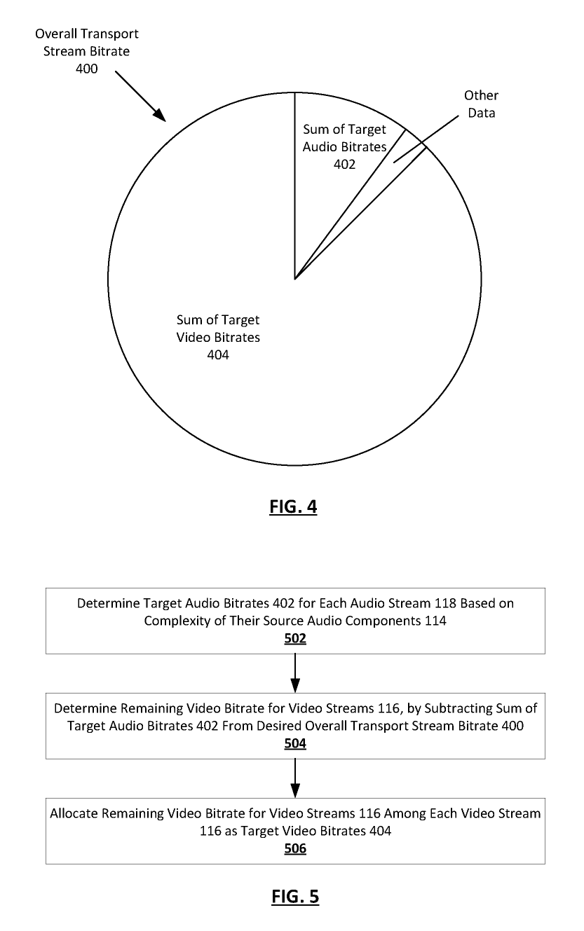

FIG. 4 depicts a pie chart illustrating the interaction between audio bitrates and video bitrates within a transport stream 120. The video encoding system 100 can be set with an overall transport stream bitrate 400 that describes a maximum bitrate for the transport stream 120. In some embodiments the overall transport stream bitrate 400 can be set at a value such that the transport stream 120 can be fully delivered to downstream client devices 122 over currently available bandwidth and/or network conditions.

The video encoding system 100 can allocate portions of the overall transport stream bitrate 400 as target audio bitrates 402 for particular audio streams 118 and target video bitrates 404 for particular video streams 116. The video encoding system 100 can allocate the target audio bitrates 402 and target video bitrates 404 such that their sum is substantially equal to the overall transport stream bitrate 400. In some embodiments, a rate controller 108 can be configured to manage allocation of the target audio bitrates 402 and target video bitrates 404. In other embodiments, video encoders 102 and audio encoders 104 can communicate between themselves to coordinate and determine target audio bitrates 402 and target video bitrates 404. In some embodiments, a portion of the overall transport stream bitrate 400 can also be reserved for other data that will be transmitted as part of the transport stream 120, such as such as program identifiers, metadata, headers, and any other desired information.

In adaptive bitrate streaming embodiments, in which the video encoding system 100 produces multiple substreams 200 at different resolutions, frame rates, and/or bitrates as shown in FIGS. 2 and 3, the video encoding system 100 can have a different target overall transport stream bitrate 400 for each substream 200 that is currently being produced. The video encoding system 100 can thus allocate audio bitrates and video bitrates for each substream 200 separately based on each version's overall transport stream bitrate 400.

In some embodiments allocation of the target audio bitrates 402 and target video bitrates 404 can depend, at least in part, on the complexity of the source content 110. By way of a non-limiting example, when multiple video encoders 102 are encoding different pieces of source content 110 for an MPTS, and one is encoding a complex scene in its source content 110 while another is encoding a relatively simple scene, the video encoding system 100 can assign a higher target video bitrate 404 to the one encoding the more complex scene.

As shown in FIG. 4, the portion of the overall transport stream bitrate 400 that is available for target video bitrates 404 can be dependent on the portion used for target audio bitrates 402. The video encoding system 100 can thus attempt to increase the portion available for target video bitrates 404 by decreasing target audio bitrates 402.

In some embodiments or situations, the target audio bitrate 402 for an audio stream 118 can be set as low as an estimated minimum bitrate at which the source audio component 114 can be encoded into an audio stream 118 without a loss in perceived audio quality to a human listener. Generally, encoding and decoding audio information is a lossy process, such that a decoded audio stream 118 is an approximation that does not match the original source audio component 114 bit for bit. However, many differences between an original source audio component 114 and a decoded audio stream 118 can be immaterial to the human ear. As such, the video encoding system 100 can set an audio stream's target audio bitrate 402 to a value that is as low as an estimated minimum bitrate at which the audio stream 118 can be encoded without a loss in perceived audio quality to a human listener when the audio stream 118 is decoded and played back, relative to the original source audio component 114.

An audio stream's target audio bitrate 402 can be a temporal value that changes over time as the complexity level of the source audio component 114 changes. In some embodiments, an audio stream's target audio bitrate 402 can be re-determined periodically for different segments of the source audio component 114. By way of a non-limiting example, an audio stream's target audio bitrate 402 can be determined for segments of the source audio component 114 comprising windows of audio frames or samples that correspond to groups of pictures (GOPs) in the associated source video component 112.

When determining a target audio bitrate 402 for a segment of a source audio component 114, based on a minimum bitrate at which the segment can be encoded without a loss in perceived audio quality to a human listener, the video encoding system 100 can review one or more factors to estimate the segment's complexity, including its volume and activity level within a human's psychoacoustic frequency range and sensitivity. When the segment is determined to have a high complexity, the minimum target audio bitrate 402 can be set higher than for a segment with a lower complexity.

In some embodiments the video encoding system 100 can review the volume levels of a segment when determining its target audio bitrate 402. In general, louder audio levels can be more complex to encode than quieter audio levels. As such, the video encoding system 100 can tend to calculate higher target audio bitrates for louder segments than for quieter segments. When the segment's audio is silent, the video encoding system 100 can set the target audio bitrate 402 to a minimal value since human listeners would perceive the same silence at any bitrate.

In some embodiments the video encoding system 100 can additionally or alternately review the variance of the audio levels in a segment over time when determining its target audio bitrate 402. In general, highly variant audio levels can be more complex to encode than monotone audio levels. As such, the video encoding system 100 can tend to calculate higher target audio bitrates 402 for segments with audio levels that vary more than other segments with consistent audio levels.

In some embodiments the video encoding system 100 can additionally or alternately review the audio frequencies of a segment when determining its target audio bitrate 402. When the source audio component's frequencies are outside the range of frequencies that humans can hear, the video encoding system 100 can set the target audio bitrate 402 to a minimal value since human listeners aren't likely to perceive the loss of those frequencies. When the source audio component's frequencies are within the range of frequencies that humans can hear, the video encoding system 100 can set the target audio bitrate 402 to higher values for frequencies that humans are more sensitive to, and to lower values for frequencies that humans can hear but are not as sensitive to. In some embodiments, the video encoding system 100 can further review the source audio component's frequencies to determine if the segment is primarily more complex sounds like music or sound effects, or less complex sounds such as lines of dialogue. By way of a non-limiting example, the frequencies of human dialogue is generally between 300 Hz and 3000 Hz. When the source audio component's frequencies are within this range such that it is likely that the segment contains primarily dialogue, the video encoding system 100 can set the target audio bitrate 402 at lower values than when the source audio component's frequencies are at other values that likely indicate more complex sounds.

In some embodiments, the video encoding system 100 can additionally or alternately review the source content's program type. Source content 110 can be submitted to the video encoding system with metadata or other information that indicates information about the source content 110, such as its name, start time, stop time, and program type. By way of non-limiting examples, Program and System Information Protocol (PSIP) tables can describe information about live television broadcasts, and information about prerecorded pieces of source content 110 can be available in databases or other information sources available to the video encoding system 100. In these embodiments, when the source content's program type is one that generally has less complex audio than other types, the video encoding system 100 can set the target audio bitrate 402 to lower values than for program types that generally have more complex audio. By way of a non-limiting example, when the source content's program type is a news broadcast, which on average primarily includes dialogue rather than complex music and sound effects, the video encoding system 100 can set the target audio bitrate 402 at lower values than when the program type indicates a type such as a movie that is likely to have more complex sounds.

In some embodiments the video encoding system 100 can additionally or alternately review the number of channels, and/or the number of active channels, within a segment when determining its target audio bitrate 402. In general, encoding complexity increases with each additional channel. As such, the video encoding system 100 can set the target audio bitrate 402 to higher values for a source audio component 114 with more channels than one with fewer channels. Similarly, although a source audio component 114 may have a particular number of channels, not all of them may be active at all times. As such, the video encoding system 100 can decrease a segment's target audio bitrate 402 relative to previous values when one or more active channels become silent or inactive.

In some embodiments, the audio encoder 104 can be preset with a bitrate range for different audio channel configurations. By way of a non-limiting example, in some embodiments the bitrate range for mono audio having a single channel can be 64-96 kbps, the bitrate range for stereo audio having two channels can be 128-192 kbps, and the bitrate range for 5.1 surround sound audio having five speaker channels plus a subwoofer channel can be 320-448 kbps. These values are exemplary only, and the bitrate ranges could be set at any other desired values for various audio channel configurations.

In some embodiments, the target audio bitrate 402 for an audio stream 118 having a particular audio channel configuration can be set at either the high or low end of the bitrate range for that audio channel configuration, based on other complexity factors described above. In other embodiments, the target audio bitrate 402 for an audio stream 118 having a particular audio channel configuration can be set at any value within the bitrate range for that audio channel configuration, based on other complexity factors described above.

In some embodiments, the target audio bitrate 402 for an audio stream 118 having a particular audio channel configuration can be set below the low end of the bitrate range for that audio channel configuration, if one or more of the channels is silent or inactive. By way of a non-limiting example, if the audio stream has a 5.1 surround sound audio channel configuration, but at a particular point in time the only sound being carried is dialog on the center channel while the other channels are silent, the audio stream's target audio bitrate 402 can be set at a bitrate in the mono or stereo bitrate ranges since only one channel is currently active. The silent channels can be encoded at a low bitrate, as a human listener would not perceive any difference between silence encoded at a high or low bitrate.

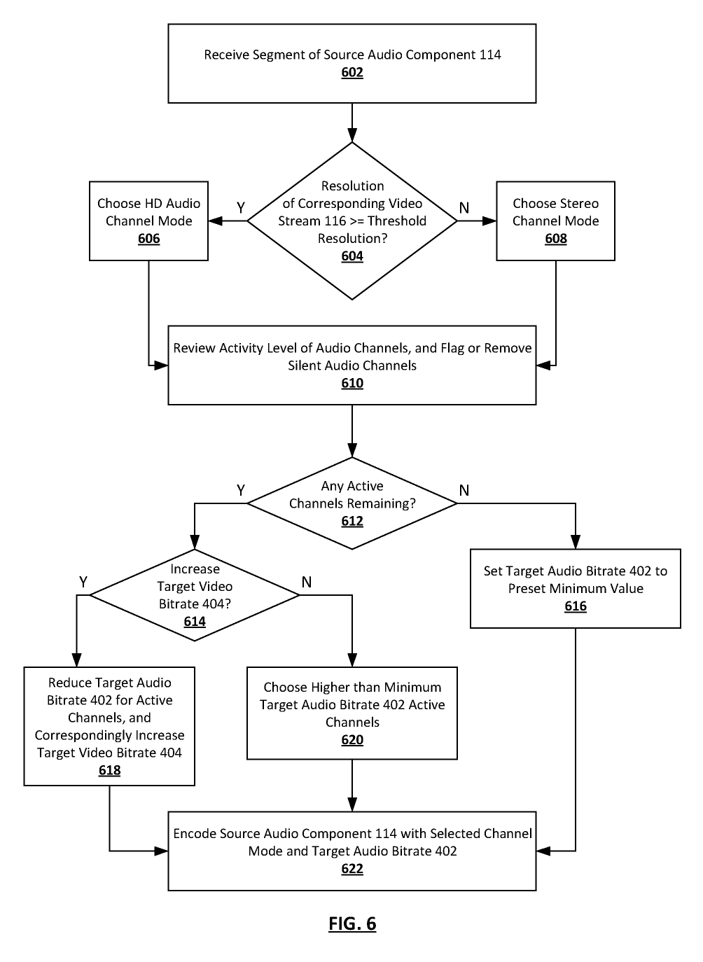

As described above, determination of the target audio bitrates 402 can alter the portion of the overall transport stream bitrate 400 available for target video bitrates 404. FIG. 5 depicts a process for determining target audio bitrates 402, and using those target audio bitrates 402 to allocate target video bitrates 404.

At step 502, the video encoding system 100 can determine target audio bitrates 402 for each audio stream 118, based on the complexity of each source audio component 114. As described above, each audio stream's target audio bitrate 402 can be as low as an estimated minimum bitrate at which the source audio component 114 can be encoded into an audio stream 118 without a loss in perceived audio quality to a human listener.

At step 504, the video encoding system 100 can find a remaining video bitrate for the video streams 116 by subtracting the sum of the target audio bitrates 402 from a desired overall transport stream bitrate 400. In some embodiments, a portion of the overall transport stream bitrate 400 can also be reserved for other data that will be included in the transport stream 120.

At step 506, the video encoding system 100 can divide and allocate the remaining available bitrate for the video streams 116 as target video bitrates 404 for each video stream 116. In some embodiments the target video bitrates 404 can be allocated equally from the remaining available bitrate for the video streams 116, while in other embodiments the target video bitrates 404 can be allocated unequally from the remaining available bitrate for the video streams 116 based on complexity and/or importance of the source video components 112.

As can be seen from FIGS. 4 and 5, when the sum of the target audio bitrates 402 decreases, the sum of the target video bitrates 404 can increase, and vice versa. By setting each target audio bitrate 402 to an estimated minimum value at which the source audio component 114 can be encoded without a loss in perceived audio quality to a human listener as described above, the portion of the overall transport stream bitrate 400 available for video streams 116 can increase. By applying more bits to the video streams 116, the perceived visual quality of one or more video streams 116 can be improved without a loss in the perceived audio quality of the audio streams 118.

By way of a non-limiting example, a video encoding system 100 can be set to encode and multiplex ten pieces of source content 110 into an MPTS using a plurality of different video encoders 102 and audio encoders 104. In this example, the overall transport stream bitrate 400 can be set at 38.8 Mbps. Without determining and using minimum target audio bitrates 402 as described above, the video encoding system 100 might allocate its 38.8 Mbps overall transport stream bitrate 400 across all of the encoders by assigning a constant bitrate of 384 kbps to each of the ten audio streams 118 and a variable bitrate averaging around 3.5 Mbps to each of the ten video streams 116.

However, in this example, if the video encoding system 100 follows the steps of FIG. 5 and finds that each target audio bitrate 402 can be as low as 192 kbps without a loss in perceived audio quality, the video encoding system 100 can save up to 192 kbps for each of the ten audio streams 118, resulting in a total bitrate savings of up to 1.92 Mbps that can be added to the remaining available bitrate for the video streams 116. The video encoding system 100 can thus use the saved 1.92 Mbps to boost the target video bitrate 404 of one or more of the ten video streams 116. As an extreme example, when one source video component 112 is much more complex than the other nine, the video encoding system 100 can keep the target video bitrates 404 for the other nine video streams 116 at an average of around 3.5 Mbps, but boost the more complex one's target video bitrate 404 by 1.92 Mbps from the average of 3.5 Mbps to 5.42 Mbps. The video encoding system 100 can thus increase the target video bitrate 404 of the most complex video stream by 54.86%, likely improving its perceived image quality. In this example, although the target audio bitrates 402 for each audio stream 118 were decreased by half relative to a constant bitrate of 384 kbps, the decrease was done without a loss in perceived audio quality in the audio streams 118 and the saved bits were applied to increase the perceived image quality of one of the video streams 116. In other situations, the saved bits can be applied across more than one video stream 116 to increase the visual quality of more than one video stream 116.

Although for simplicity this example described a target audio bitrate 402 that was the same for each of the audio streams 118, the target audio bitrate 402 vary over time and be different for each audio stream 118 depending on the factors described above. As such, the sum of the target audio bitrate 402 across all audio streams 118 can change over time, which can lead to corresponding changes in the remaining available bitrate for the video streams 116.

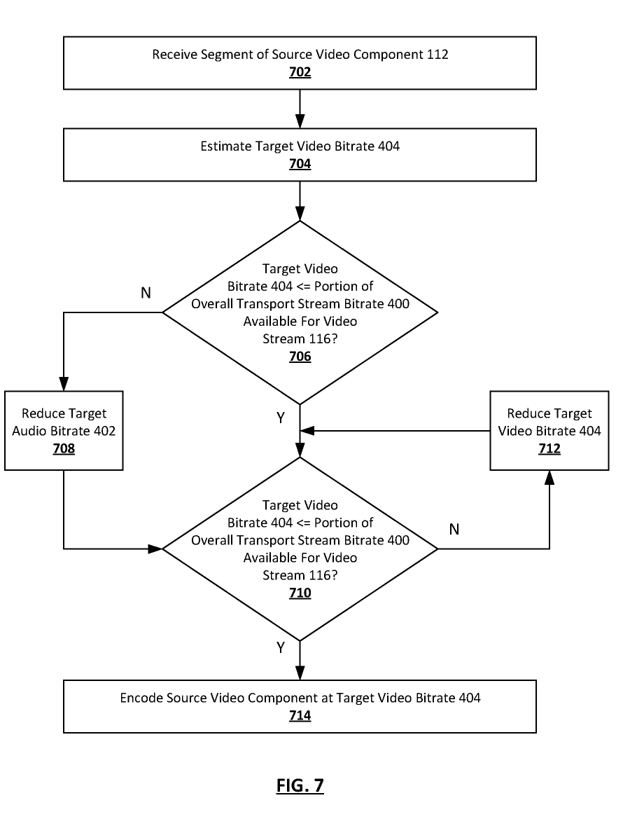

FIG. 6 depicts a flow chart of one exemplary method for adaptively determining a target audio bitrate 402 and a target video bitrate 404 for a piece of source content 110, based in part on determining an estimated minimum value for the target audio bitrate 402 at which the source audio component 114 can be encoded without a loss in perceived audio quality to a human listener.

At step 602, the audio encoder 104 can receive a segment of the source audio component 114, such as a single audio frame or sample, or a series of audio frames or samples.

At step 604, the audio encoder 104 can determine whether a corresponding source video component 112 is being encoded into a video stream 116 at or above a threshold resolution. In some embodiments, the threshold resolution can be set at a minimum resolution for high definition video, such that video streams 116 being encoded at 720 p, 1080 p, or 4K would at or above the threshold resolution. The audio encoder 104 can have been previously informed of the resolution the video encoder 102 is using to encode the video stream 116 through communications with the video encoder 102, or it can query the video encoder 102 for that information if it has not yet been informed of the video stream's resolution.

If the audio encoder 104 determines during step 604 that the video stream 116 is being encoded at or above the threshold resolution, the audio encoder 104 can set the audio stream 118 to be produced in high definition audio channel mode at step 606, and then move to step 610.

If the audio encoder 104 instead determines during step 604 that the video stream 116 is being encoded below the threshold resolution, the audio encoder 104 can set the audio stream 118 to be produced in stereo channel mode at step 608, and then move to step 610.

At step 610, the audio encoder 104 can review the source audio component 114 for the activity level on each channel, and flag or remove any silent audio channels. By way of a non-limiting example, if the source audio component 114 is a 5.1 surround sound audio track, but the rear channels are currently silent, the rear channels can be flagged or removed.

At step 612, the audio encoder 104 can determine the number of active channels in the source audio component 114. If the audio encoder 104 determines during step 612 that at least one channel in the source audio component 114 is active and was not flagged or removed during step 610, the audio encoder 104 can move to step 614.

However, if all of the channels were flagged or removed during step 610, indicating that all of the channels in the source audio component 114 are silent, the audio encoder 104 can set the target audio bitrate 402 to a preset minimum value at step 616 before moving to step 622. In some embodiments the preset minimum value set during step 616 can be the value at the low end of a preset bitrate range for a mono audio channel configuration having one channel, as silent audio can be encoded at that bitrate without a loss in perceived quality to a human listener.

At step 614, the audio encoder 104 can coordinate with the video encoder 102 and/or rate controller 108 to determine if the target audio bitrate 402 should be decreased and the target video bitrate should be proportionally increased, based on the complexity level of the source video component 112.

If the complexity level of the source video component 112 is high enough that it would not be encoded at acceptable visual quality levels with a target video bitrate 404 allocated from the portion of the overall transport stream bitrate 400 dedicated to video streams 116, the audio encoder 104 can move to step 618 and select an estimated minimum target audio bitrate 402 that would not result in a loss of perceived audio quality to a human listener, as discussed above. Selecting a minimum target audio bitrate 402 can increase the proportion of the overall transport stream bitrate 400 remaining for video streams 116, such that the target video bitrate 404 for the complex source video component 112 can be increased. The audio encoder 104 can then move to step 622.

However, if the complexity level of the source video component 112 is low enough that it can be encoded at acceptable visual quality levels with a target video bitrate 404 allocated from the portion of the overall transport stream bitrate 400 dedicated to video streams 116, the audio encoder 104 can move to step 620 and select a higher than minimum target audio bitrate 402 for the audio stream 118. The audio encoder 104 can then move to step 622.

At step 622, the audio encoder 104 can encode the segment of the source audio component 114 into an audio stream 118 at the selected target audio bitrate 402 and selected channel mode. The audio encoder 104 can provide the audio stream 118 to the multiplexor 106, such that it can be multiplexed into the transport stream 120 along with a corresponding video stream 116 encoded at the selected target video bitrate 404.

In some embodiments, the audio encoder 104 can return to step 602 to continue the process for the next segment of the source audio component 114. In alternate embodiments, the audio encoder 104 can be at different stages of the process for different segments of the source audio component 114 at any one time.

FIG. 7 depicts a flow chart of a method for determining target audio bitrates 402 and target video bitrates 404 for an SPTS (Single Program Transport Stream), based in part on determining an estimated minimum value for the target audio bitrate 402 at which the source audio component 114 can be encoded without a loss in perceived audio quality to a human listener. The process of FIG. 7 can be used to allocate bitrates for a single SPTS, and/or for each of a plurality of substreams 200 being produced for adaptive bitrate streaming.

At step 702, the video encoder 102 can receive a segment of the source video component 112, such as a Group of Pictures (GOP).

At step 704, the video encoder 102 or a rate controller 108 can estimate a target video bitrate 404 that would result in a video stream 116 with adequate or desired image quality. The target video bitrate 404 can be estimated based on the image complexity level of the segment of the source video component 112.

At step 706, the video encoder 102 or rate controller 108 can compare the estimated target video bitrate 404 against the portion of the overall transport stream bitrate 400 that is available for the video stream 116.

If the video encoder 102 or rate controller 108 find during step 706 that the estimated target video bitrate 404 is at or below the portion of the overall transport stream bitrate 400 that is available for the video stream 116, the video encoder 102 or rate controller 108 can move directly to step 710. In this situation, the target audio bitrates 402 for associated audio streams 118 can be left at a preset value, or otherwise be determined based on factors described above.

However, if the video encoder 102 or rate controller 108 find during step 706 that the estimated target video bitrate 404 is higher than the portion of the overall transport stream bitrate 400 that is currently available for the video stream 116, the video encoder 102 or rate controller 108 can move to step 708. At step 708, the rate controller 108 or an audio encoder 104 can reduce the target audio bitrate 402 for an associated audio stream 118 from a preset value to a value that is as low as an estimated minimum target audio bitrate 402 that would not result in a loss of perceived audio quality to a human listener, as discussed above. Reducing the target audio bitrate 402 for an associated audio stream 118 can increase the proportion of the overall transport stream bitrate 400 remaining for the video stream 116. The video encoder 102 or rate controller 108 can thus increase the video target bitrate 404 by as much as the target audio bitrate 402 was reduced. In embodiments or situations where there are multiple source audio components associated with a single source video component, the video encoding system 100 can reduce the target audio bitrate 402 for more than one of them, in order to further increase the video target bitrate 404. After reducing the target audio bitrate 402 for one or more audio streams 118 during step 708, the video encoder 102 or rate controller 108 can move to step 710.

At step 710, the video encoder 102 or rate controller 108 can compare the current value of the target video bitrate 404 against the portion of the overall transport stream bitrate 400 that is now available for the video stream 116. As discussed in step 708, decreasing the target audio bitrate 402 for one or more audio streams 118 can have increased the portion of the overall transport stream bitrate 400 that is now available for the video stream 116.

If the video encoder 102 or rate controller 108 find during step 710 that the current value for the target video bitrate 404 is at or below the portion of the overall transport stream bitrate 400 that is now available for the video stream 116, the video encoder 102 can move directly to step 714 to encode the source video component 112 at the target video bitrate 404. Audio encoders 104 can simultaneously be encoding one or more source audio components 114 at their target audio bitrates 402, which may have been decreased during step 708. The encoded video stream 116 and audio streams 118 can be multiplexed together by the multiplexor.

However, if the video encoder 102 or rate controller 108 find during step 710 that the current value for the target video bitrate 404 is still above the portion of the overall transport stream bitrate 400 that is now available for the video stream 116, the video encoder 102 or rate controller 108 can move to step 712. At step 712, the video encoder 102 or rate controller 108 can reduce the target video bitrate 404 down to the portion of the overall transport stream bitrate 400 that is now available for the video stream 116. After reducing the target video bitrate 404, the video encoder 102 or rate controller 108 can return to step 710 to verify that the target video bitrate 404 is now at or below the portion of the overall transport stream bitrate 400 available for the video stream 116, before moving to step 714 to encode the video stream 116 at that target video bitrate 404.

At step 714, the video encoder 102 can encode the segment of the source video component 112 into a video stream 116 at the selected target video bitrate 404. The video encoder 102 can provide the video stream 116 to the multiplexor 106, such that it can be multiplexed into the transport stream 120 along with one or more corresponding audio streams 118 encoded at the selected target audio bitrates 402.

In some embodiments, the video encoder 102 can return to step 702 to continue the process for the next segment of the source video component 112. In alternate embodiments, the video encoder 102 can be at different stages of the process for different segments of the source video component 112 at any one time.

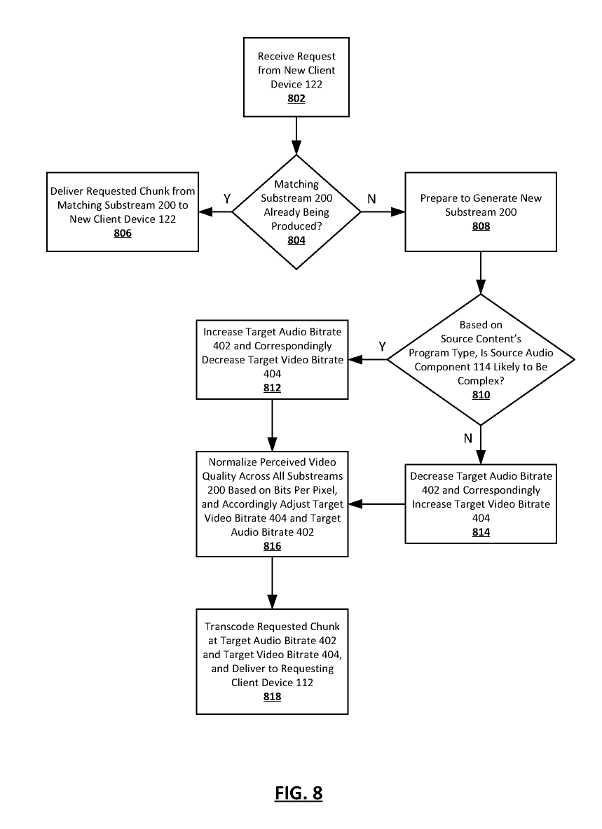

FIG. 8 depicts a flow chart of a method for determining target audio bitrates 402 and target video bitrates 404 for substreams 200 for “just-in-time” adaptive bitrate transcoding.

At step 802, the video encoding system 100 can receive a request for a chunk of source content 110 from a client device 122. In some embodiments the request can be passed through an intermediate server 202. The client device's request can include information about the requesting client device 122, such as its type, operating system, display resolution, and/or audio configuration. The client device's request can also include information identifying the chunk it is requesting and a requested bitrate.

At step 804, the video encoding system 100 can determine if the requested chunk is being produced, or has already been produced, with attributes such as resolution, framerate, audio configuration, and bitrate, appropriate for the new client device 122 based on its request.

In some embodiments, the video encoding system 100 can be preset with a plurality of device profiles that it can use to set attributes such as the resolution, framerate, and audio configuration for the requested chunk if the client device's request did not include that information. By way of a non-limiting example, the video encoding system 100 can determine from a device type in the request's header that the client device 122 is a mobile device or web client, and use a matching device profile to set the requested resolution and audio configuration to a resolution and audio configuration normally used for such devices, such as 720 p resolution and stereo audio. By way of another non-limiting example, when the video encoding system 100 determines from the request's header that the client device 122 is a set-top box likely connected to a high definition television, it can use a matching device profile to set the requested resolution and audio configuration to a resolution and audio configuration normally used for such devices, such as 1080 p resolution and 5.1 surround sound audio.

If the requested chunk is being produced, or has already been produced, at the requested or inferred attributes, the video encoding system 100 can deliver a copy of the requested chunk with those attributes to the client device 122 at step 806. By way of a non-limiting example, if the new client device 122 is a cable box connected to high definition television with a 1080 p resolution, and the video encoding system 100 is already producing a substream 200 at 1080 p at the requested bitrate for other cable boxes, the video encoding system 100 can deliver the requested chunk from that substream 200. However, if the requested chunk is not being produced, or has not previously been produced, with the requested or inferred attributed, the video encoding system can move to step 808.

At step 808, the video encoding system 100 can set initial values for attributes of a new substream 200 that will be produced for the new client device 122. The video encoding system 100 can set the overall transport stream bitrate 400 to the bitrate in the client device's request. It can set the resolution, framerate, and/or audio configuration either to values explicitly included in the client device's request or to preset values according to a matching device profile. By way of a non-limiting example, if the client device 122 is a set-top box or television, the resolution can be set to a high definition resolution and audio configuration can be set to surround sound, while if the client device 122 is a web browser or application running on a smartphone, the resolution can be set to the smartphone's resolution or the resolution or a display window and the audio configuration to mono or stereo. The video encoding system 100 can allocate the target audio bitrate 402 and target video bitrate 404 from the overall transport stream bitrate 400 based on preset initial values or percentages.

At step 810, the video encoding system 100 can estimate the audio complexity of the source audio component 114 based on the source content's audio content type. The source content's audio content type can be determined by reviewing the source content's program type, and/or reviewing the audio frequencies of the source content 110. The program type can indicate whether the source content 110 is likely to be include relatively complex audio information such as music and sound effects, or whether it is primarily less complex dialogue. By way of a non-limiting example, when the program type is a news broadcast that is likely to primarily contain dialogue, the video encoding system 100 can determine that the audio complexity is likely lower than if the program type was a movie. The source content's audio frequencies can also provide an estimate of the audio complexity. If the frequencies are within a range that generally indicates dialogue, such as between 300 Hz and 3000 Hz, the video encoding system 100 can determine that the audio complexity is likely lower than if the frequencies are in other ranges.

If the video encoding system's estimate of the source audio component's complexity shows that it is higher than a threshold value, the video encoding system 100 can move to step 812 to increase the target audio bitrate 402 and correspondingly decrease the target video bitrate 404. If the video encoding system's estimate of the source audio component's complexity shows that it is lower than a threshold value, the video encoding system 100 can move to step 814 to decrease the target audio bitrate 402 and correspondingly increase the target video bitrate 404.

At step 816, the video encoding system 100 can further adjust the target video bitrates 404 to normalize the bits per pixel across each substream 200 being produced. By way of a non-limiting example, when three substreams 200 are being produced at different resolutions, framerates, and/or target video bitrates 404, each can have different bits per pixel, calculated by dividing each one's target video bitrate 404 by the resolution and framerate. To attempt to ensure that each substream is being produced at substantially similar perceived quality levels despite differences in resolution and framerate, the video encoding system 100 can attempt to keep the bits per pixel of each at substantially similar values. In some embodiments, the video encoding system 100 can increase or decrease each substream's target video bitrate 404 by a factor calculated by dividing the substream's bits per pixel value by a median bits per pixel value across all of the substreams, multiplying by a first value and adding a second value. The first and second values can differ for each substream, and be pre-set or experimentally determined based on the substream's resolution and framerate. If the video encoding system 100 increases or decreases a substream's target video bitrate 404 to normalize perceived video quality levels across all the substreams, the video encoding system 100 can also decrease or increase the substream's target audio bitrate 402 by a corresponding amount.

At step 818, after the target audio bitrate 402 and target video bitrate 404 have been proportionally allocated from the overall transport stream bitrate 400, the video encoding system 100 can encode or transcode the requested chunk at the target audio bitrate 402 and target video bitrate 404. The chunk can also be encoded with the other attributes that were explicitly requested or inferred from device profiles, such as resolution, framerate, and/or audio configuration. The requested chunk can then be delivered to the requesting client device 122.

After sending a chunk to the client device 122, the video encoding system 100 can return to step 802 to await another request for a subsequent chunk from the client device 122. In some situations the next request can be essentially similar except for requesting a different chunk, but in other situations the next request can request a subsequent chunk at a different bitrate, such as if the client device's available bandwidth has changed. Accordingly, the video encoding system 100 can prepare and deliver the next chunk at the requested resolution according to the steps of FIG. 8.

Although the present invention has been described above with particularity, this was merely to teach one of ordinary skill in the art how to make and use the invention. Many additional modifications will fall within the scope of the invention, as that scope is defined by the following claims.

1. A method of encoding digital content, comprising:
determining, with a video encoding system, an overall transport stream bitrate for a transport stream;
determining, with said video encoding system, a target audio bitrate for each of one or more audio streams based on the complexity of one or more associated source audio components;
determining, with said video encoding system, a portion of said overall transport stream bitrate that is available for video streams, by subtracting the sum of said target audio bitrates from said overall transport stream bitrate;
allocating, with said video encoding system, a target video bitrate for each of one or more video streams out of the portion of said overall transport stream bitrate that is available for video streams;
encoding said one or more audio streams at said target audio bitrates with one or more audio encoders;
encoding said one or more video streams at said target video bitrates with one or more video encoders; and
combining said one or more audio streams and said one or more video streams with a multiplexor into a transport stream.

2. The method of claim 1, wherein management of said target video bitrates and said target audio bitrates is performed by a rate controller linked with said one or more audio encoder and one or more video encoders.

3. The method of claim 1, wherein the complexity of a source audio component is determined by said video encoding system at least in part based on its volume level.

4. The method of claim 1, wherein the complexity of a source audio component is determined by said video encoding system at least in part based on its activity level within a human's psychoacoustic frequency range.

5. The method of claim 1, wherein the complexity of a source audio component is determined by said video encoding system at least in part based on the number of active channels.

6. The method of claim 1, wherein each target audio bitrate is set within a range of preset values for an associated audio channel configuration.

7. A method of encoding digital content, comprising:
receiving a segment of a source audio component at an audio encoder, said audio source component having one or more channels;
setting a target audio bitrate at said audio encoder;
decreasing said target audio bitrate at said audio source component and increasing target video bitrates at one or more linked video encoders when one or more video encoders requests an increase in their target video bitrates based on the complexity level of source video components; and
encoding said segment at said target audio bitrate into an audio stream.

8. The method of claim 7, further comprising providing said audio stream to a multiplexor to be combined with one or more video streams into a transport stream.

9. The method of claim 7, further comprising encoding said segment at a minimum preset audio bitrate when all of said one or more channels are silent.

10. The method of claim 7, wherein said target audio bitrate is decreased to as low as a minimum value based at least in part on its volume level.

11. The method of claim 7, wherein said target audio bitrate is decreased to as low as a minimum value based at least in part on its activity level within a human's psychoacoustic frequency range.

12. The method of claim 7, wherein said target audio bitrate is decreased to as low as a minimum value based at least in part on the number of active channels within said one or more channels.

13. The method of claim 7, wherein said target audio bitrate is set within a range of preset values for a particular configuration of said one or more channels.

14. The method of claim 7, wherein a rate controller in communication with said audio encoder and one or more video encoders manages adjustment of said target video bitrates and said target audio bitrate.

15. A method of encoding digital content, comprising:
receiving a segment of a source video component at a video encoder;
estimating a target video bitrate with said video encoder for a video stream, based on the complexity level of said source video component;
decreasing a target audio bitrate for an audio stream to as low as a minimum preset value for said audio stream's channel configuration based on said audio stream's complexity level and increasing said target video bitrate by a corresponding amount, upon a determination that said target video bitrate is higher than a portion of an overall transport stream bitrate available for said video stream;
encoding said segment at said target video bitrate; and
encoding said audio stream at said target audio bitrate.

16. The method of claim 15, further comprising decreasing said target video bitrate down to said portion of said overall transport stream bitrate available for said video stream after decreasing said target audio bitrate to said minimum preset value when said target video bitrate is still higher than said portion of said overall transport stream bitrate available for said video stream.

17. The method of claim 15, wherein the complexity of an audio stream is determined at least in part based on its volume level.

18. The method of claim 15, wherein the complexity of an audio stream is determined by at least in part based on its activity level within a human's psychoacoustic frequency range.

19. The method of claim 15, wherein the complexity of an audio stream is determined at least in part based on the number of active channels.

20. The method of claim 15, wherein said target audio bitrate is set within a range of preset values for said channel configuration.
